(19) United States
(12) Patent Application Publication
(10) Pub. No.: US 2003/0220987 A1
(43) Pub. Date: Nov. 27, 2003

(54) System and method with environment memory for input/output configuration

(75) Inventor: Jeffery Pearson, Peoria, AZ (US)

Correspondence Address: Squire, Sanders & Dempsey L.L.P., Two Renaissance Square, 40 North Central Avenue, Suite 2700, Phoenix, AZ, 85004-4498, US

(73) Assignee: Aviation Communication & Surveillance Systems, LLC

(21) Appl. No.: 10/153,285

(22) Filed: May 21, 2002

(51) Int. Cl. G06F 15/177

(52) U.S. Cl. 709/220

(57) ABSTRACT

A system having replaceable subsystems is operable in a certified configuration after installation of a replacement subsystem. The system includes several subsystems each installed at an interface. For each subsystem, the interface includes memory having a description of the operating environment for that subsystem. The memory stores modules each having a signature, for example, a cyclic redundancy code (CRC). A method performed by a subsystem of the plurality includes, in any order, (a) obtaining data provided by the memory, the data comprising a multiplicity of respective pluralities of rows; (b) storing each respective plurality of rows so that all rows identified for each respective table may be accessed in series without accessing rows of any other than the respective table; and (c) communicating with other subsystems in accordance with rows of the tables. Each plurality of rows is identified for at least one particular table of a set of tables. There is no reference in the data from a first plurality of rows of the multiplicity identified for a particular table to a second plurality of rows of the multiplicity identified for the same table.

### FIELD OF THE INVENTION

Embodiments of the present invention relate to systems having replaceable subsystems and memory read by a subsystem for configuration of the subsystem; and to methods that use the contents of memory, for example, for initializing or configuring a subsystem and its application programs.

### BACKGROUND OF THE INVENTION

Conventional systems are packaged to facilitate maintenance and upgrades by permitting portions of a system to be removed and replaced with a functionally compatible replacement portion. Such portions may be equivalently referred to as subsystems, system components, replaceable units, or line replaceable units (LRUs). A subsystem may be operated by itself apart from the rest of the system for testing, though such operation may be somewhat different from typical system operation, for example, to facilitate diagnostics, analysis of extreme conditions, measurement, calibration, monitoring of internal signals, debugging, or special purpose tests. The specified performance of a subsystem is typically defined for system level operations and may also be defined at the subsystem level by specifying sequences of inputs and acceptable outputs of the subsystem.

Certifying the performance of a subsystem typically includes ascertaining and recording the identity and configuration of the subsystem, isolating the subsystem from other system components (e.g., to assure performance isn't masked by other subsystems), conducting tests using instrumentation that has been properly calibrated, recording that each step of a test was performed properly with an acceptable result, and recording that all testing was completed satisfactorily. The time, labor, equipment utilization, and management associated with certifying a subsystem represent a costly investment aimed at assuring proper operation of the system under all system operating conditions.

Conventional subsystem design in electronics and software places emphasis on modular design techniques for decreasing development time. These modules may be circuits, circuit assemblies, memory devices, integrated circuits, application specific integrated circuits, or portions of software handled as a unit during software development processes. Such portions of software may include data or instructions in any form readable by human programmers or machines. Subsystems as a whole, and all internal modules, may be designed to perform according to one or more predefined configurations. Typically, a configuration corresponds to prescribed conditions of signals at an electrical interface of the subsystem or module, or to prescribed contents of a memory device. A configuration may establish an initial operating mode (or set of modes) or may, upon configuration change, establish a different mode (or set of modes) for further operations.

Conventional subsystems have been designed to operate with centralized control of subsystem modules. For example, all hardware and software modules for an airplane cockpit system function such as a collision avoidance system computer for a collision avoidance system have been packaged as a line replaceable unit. Also, a system may be installed in a variety of environments, each characterized by different system operations or operational modes. Consequently, for a given subsystem, all modules that may be necessary or desirable for all system environments have typically been included in the subsystem. As the number of environments and the complexity of the system and subsystem increase, the cost of certification of the subsystem has dramatically increased.

Without systems and methods of the present invention, further development of systems and subsystems may be impeded. Development, operating, and maintenance cost targets and performance reliability goals may not be met using conventional system design as discussed above. Consequently, important systems for assuring safety of personnel and equipment may not implemented to avoid injury, loss of life, and destruction of property.

### SUMMARY OF THE INVENTION

A system, according to various aspects of the present invention, has a plurality of subsystems coupled for communication among the subsystems. A method performed by a subsystem of the plurality includes, in any order, (a) obtaining data provided by a memory, the data comprising a multiplicity of respective pluralities of rows; (b) storing each respective plurality of rows so that all rows identified for each respective table may be accessed in series without accessing rows of any other than the respective table; and (c) communicating with other subsystems in accordance with rows of the tables. The subsystem is removably coupled to the memory. The memory is for subsystem configuration control. Each plurality of rows is identified for at least one particular table of a set of tables. And, there is no reference in the data from a first plurality of rows of the multiplicity identified for a first table to a second plurality of rows of the multiplicity identified for the first table.

By combining rows to form tables, rows for the same type of I/O (e.g., similar device, or similar I/O function) may be grouped for simplicity of defining, certifying, tracking, and installing an I/O configuration. By storing rows in the memory (prior to operation of the method) without regard to table structure, by storing rows in the memory (prior to operation of the method) prior to combining rows into a table, and by combining rows read from the memory to form particular tables, access to tables is made more efficient without forcing an order onto how the rows are stored in the memory.

A system according to various aspects of the present invention, has a plurality of subsystems coupled for communication among the subsystems. A method performed by a subsystem of the plurality includes, in any order, (a) obtaining data provided by a memory, the data comprising values and symbolic addresses that refer to particular ones of the values; (b) storing the values in respective physical addresses; and (c) linking the values so that each value referred to by a symbolic address is accessed instead with reference to a physical address so that communication between the subsystem and other subsystems of the plurality is accomplished in accordance with the linked values. The subsystem is removably coupled to the memory. The memory is for subsystem configuration control.

A method, according to various aspects of the present invention, is performed by an avionics subsystem, the subsystem being one of a plurality of subsystems that communicate as a system. The method includes, in any order, (a) forming a first table; (b) forming a second table. (c) linking a particular row of the first table to a particular row of the second table; and (d) executing processes that communicate with other subsystems in accordance with the first table and the second table. The first table has a plurality of rows including the first particular row. Each row of the first table is formed in memory internal to the subsystem in accordance with at least one component stored in memory external to the subsystem. The first table describes at least one communication path between the subsystem and other subsystems. The second table describes message content for communicating between the subsystem and other subsystems. The second table has a plurality of rows including the second particular row. Each row of the second table is formed in memory internal to the subsystem in accordance with at least one component stored in memory external to the subsystem. Each component includes a respective plurality of rows and is identified by a respective signature. At least one row of any component includes a symbolic row reference. At least one row of any component includes a symbolic data reference. Linking the first particular row to the second particular row is accomplished in accordance with a physical address of the internal memory so as to implement the symbolic row reference. Linking provides access by an avionics application program of the subsystem to message content described by a handle in a row of the second table for at least one of a send communication and a receive communication. The application program gains knowledge of the handle after formation of the first table and the second table.

A method, according to various aspects of the present invention, is performed by a subsystem of a system. The system includes the subsystem and a plurality of other subsystems. The subsystem is coupled to an environment memory. The method includes: (a) obtaining data provided by the environment memory, the data comprising a multiplicity of respective pluralities of rows, each plurality being identified for at least one of a first table and a second table, there being no reference in the data from a first plurality of the multiplicity identified for the first table to a second plurality of the multiplicity identified for the first table, there being no reference in the data from a third plurality of the multiplicity identified for the second table to a fourth plurality of the multiplicity identified for the second table; (b) storing each respective plurality of rows so that all rows identified for each respective table may be accessed in series without accessing rows of any other than the respective table; and (c) communicating with a particular other subsystem of the plurality of other subsystems in accordance with a buffer and a process, the buffer being identified by a row of the first table, the process being identified by a row of the second table.

### BRIEF DESCRIPTION OF THE DRAWING

Embodiments of the present invention will now be further described with reference to the drawing, wherein like designations denote like elements, and:

FIG. 1 is a functional block diagram of system according to various aspects of the present invention;

FIG. 2 is a data flow diagram of a process performed in a subsystem 104 of FIG.

FIG. 3 is a data structure diagram of data stored in the environment memory 106 of FIG. 1;

FIG. 4 is a data flow diagram of a process performed in a subsystem 104 of the system of FIG. 1;

FIG. 5 is a functional block diagram of a collision avoidance system according to various aspects of the present invention;

FIG. 6 is a memory map of a portion of the contents of an environment memory of FIG. 5;

FIG. 7 is a memory map of a portion of the memory map of FIG. 6;

FIG. 8 is a flow chart of a method for initializing a subsystem of FIG. 1; and

FIG. 9 is a flow chart of a method for interpreting instrument I/O in a subsystem of FIG. 1.

### DETAILED DESCRIPTION OF THE PREFERRED EMBODIMENTS

Systems as discussed herein include electronic, electromechanical, electro-optical, and electrochemical apparatus implemented to accomplish any system purpose or objective including machine control and process control in any field of endeavor, for example, manufacturing, transportation, and data processing, to name a few. Generally, a subsystem includes a few (e.g., one to twenty) assemblies (also called units) that communicate or coordinate to accomplish some of the functions desired to accomplish a system purpose. System design generally proceeds to define subsystems so as to reduce the extent of interaction between subsystems, in other words, to simplify the interfaces between subsystems.

Subsystems, according to various aspects of the present invention, are economically designed for certified operation in many different system environments. Subsystems may be associated with lower costs of operation, for example, operator training may be simpler, maintenance costs may be amortized more widely, and a smaller inventory of spare parts may be sufficient.

Systems may be maintained and upgraded by removing and replacing subsystems. A replacement subsystem may have more capability than the removed subsystem to effect a system upgrade. It is desirable to be able to use any replaceable subsystem of a given type as a replacement into any of a wide variety of systems designed generally for a type of subsystem. Common maintenance facilities are typically used to service a large number of systems that may have been deployed over a period of time and so consist of various versions of each of several subsystems. A system maintained and upgraded by removal and replacement of subsystems preferably uses certified subsystems designed for interoperability.

A system having replaceable subsystems, according to various aspects of the present invention, includes an interface at which a particular replaceable subsystem is removed and installed. After installation, the new subsystem performs a method as discussed below, that defines an operating configuration of the subsystem to assure that the subsystem will operate in a manner that conforms to predetermined operating specifications. Subsystems may be certified (e.g., after inspections, measurements, or tests) as operable within ranges of acceptable performance defined in a subsystem specification. Subsystems according to various aspects of the present invention reduce the labor and equipment used to accomplish subsystem certification.

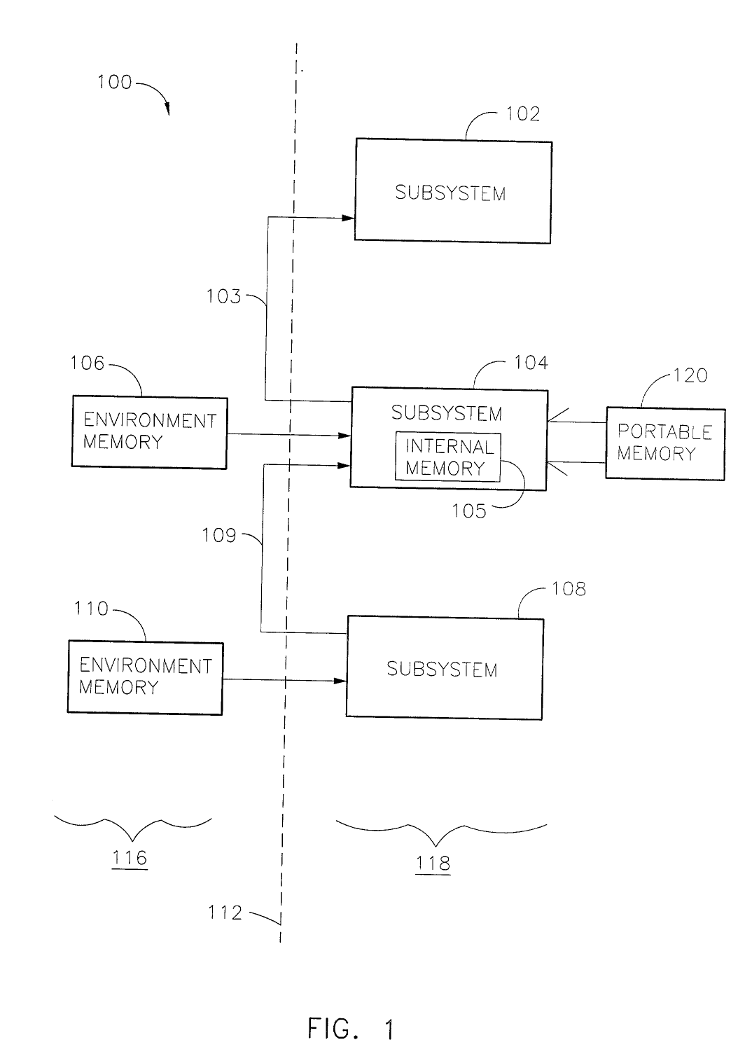

For example, system 100 of FIGS. 1-3 includes subsystems 102, 104, and 108 that cooperate. An interface 112 couples subsystems 102, 104, and 108 for the exchange of electrical and/or optical communication and power signals. Interface 112 may include electrical cables and electrical connectors and mechanical supports (e.g., rack mounts, or trays) for the assemblies that constitute each subsystem. Interface 112 defines two sides 116 and 118. Interface 112 may be implemented in any convenient manner not necessarily a continuous surface or plane; and sides 116 and 118 may occupy any convenient spatial orientation including independent spaces, overlapping spaces, and enveloping spaces. Therefore, a side is a convenient term merely to distinguish in some systems a relatively less replaceable portion of a system (e.g., cable assemblies 103, 109, rack mounts, and trays) from a more easily replaceable portion (e.g., subsystems, or line replaceable units).

System 100 further includes environment memory 106 coupled to subsystem 104 and environment memory 110 coupled to subsystem 108. Environment memories 104 and 106 are located on side 116, the relatively less replaceable portion of system 100. According to various aspects of the present invention, a subsystem 104 (108) receives data from environment memory 104 (110) to accomplish configuration of the subsystem 104 (108) and to assure proper (e.g., certifiable or certified) operation of system 100.

An environment memory includes any memory device (e.g., electronic, magnetic, optical, rotating media, or solid state) that stores data used to define, establish, or modify a configuration of a subsystem for use by an application program performed by the subsystem. According to various aspects of the present invention, such data is organized in modules that may be stored in any manner convenient for read or write access. For example, modules describing interaction between subsystem 104 and 108 may be arranged contiguously after modules describing interaction between subsystem 104 and 102. Modules may provide, describe, or limit system functions, provide parameters used to determine system performance, identify or describe subsystems (e.g., type, version, or configuration of optional features), or describe interaction, cooperation, coordination, or priority among subsystems.

A module may include data structures (e.g., discrete data, contiguous storage of data conforming to a format, a record or records, a frame or frames, a page or pages, a linked list, an array, or a string). Because a data structure may include other data structures, the entire environment memory contents, and any mix of one or more components and/or modules may be implemented as a data structure.

The contents of environment memory may be loaded prior to system installation (e.g., read only memory), or may be updated (e.g., any nonvolatile memory) by transferring data from a subsystem to the environment memory. For example, subsystem 104 includes internal memory 105 that may store a working copy of data read from environment memory 106. Further, portable memory 120 may be coupled to subsystem 104 for transferring data from portable memory 120 to internal memory 105. Data from either portable memory or from internal memory may be transferred to update environment memory 106.

Environment memory 106 includes modules that describe the version, capabilities, and interface between subsystem 102 and subsystem 104; modules that describe the version, capabilities, and interface between subsystem 108 and subsystem 104; and modules that describe the environment of system 100, including behavioral parameters of system 100 and behavioral parameters for subsystem 104 behaviors (e.g., modes of operation, ranges of inputs and/or outputs, and criteria for decision making by subsystem 104).

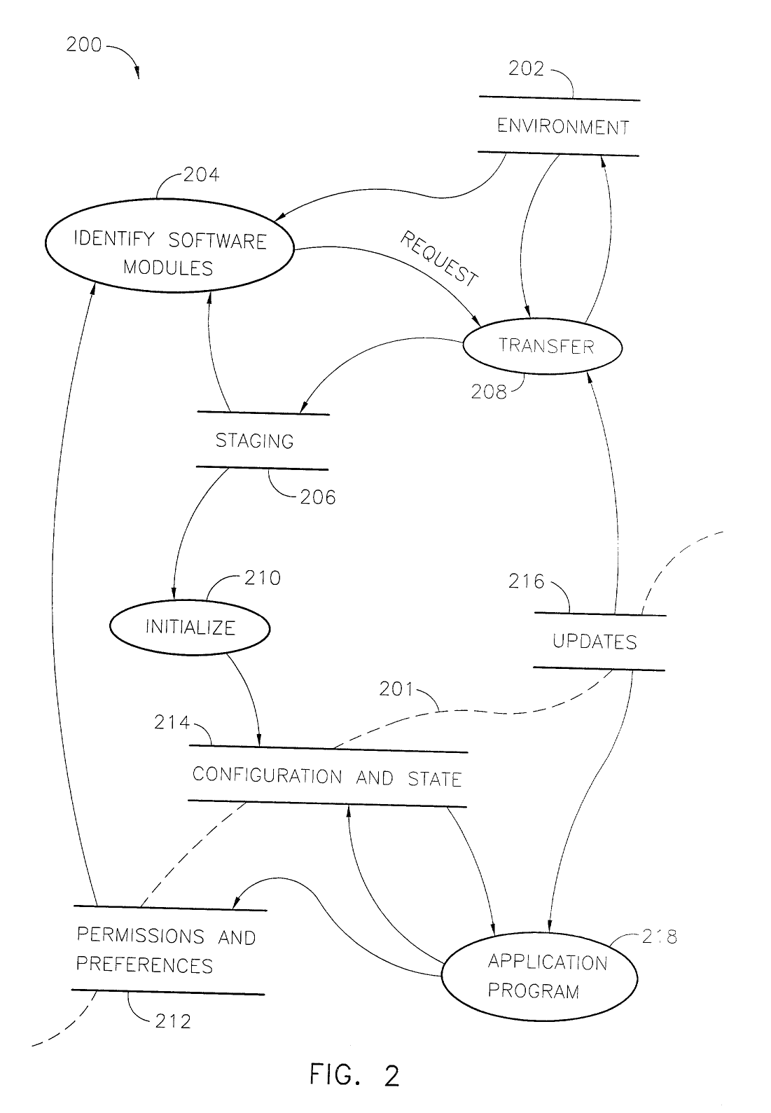

A method, according to various aspects of the present invention, activates and updates a certified configuration of an application program of an installed replaceable subsystem. The method includes processes arranged to cooperate across an interface. The interface is defined to facilitate economical deployment of environment information in modules. For example, method 200 of FIG. 2 includes an environment side and an application side of an interface 201. The environment side includes environment store 202, identify software modules process 204, staging store 206, transfer process 208, and initialize process 210. Communication across interface 201 is implemented with access to a series of stores read and written by processes on opposite sides of the interface. The series includes permissions and preferences store 212, configuration and state store 214, and update store 216. The application program side of interface 201 includes application program process 218. Processes may be implemented in any conventional manner including single flow of control, polling, interrupt driven, multithreading, multitasking, and multiprocessing technologies. Any processes may be performed whenever data sufficient for that process is available. Method 200 is discussed below as implemented in internal memory 105 of subsystem 104. A corresponding method may be implemented in subsystem 108 with update store 216 omitted and commensurate simplifications of processes 208 and 218.

Environment store 202 provides nonvolatile storage of modules as discussed above. In one implementation, environment memory 106 (or 110) includes environment store 202 for use by subsystem 104 (or 108). Modules may be identified by a signature. The signature of a module may be stored with the module or stored separately. The signature of a module may be an assigned value or may be a derived value calculated at any time by analysis of the module. For example, a signature may be a parity, a cyclic redundancy code, or a serial number. The signature may be stored with the module overtly or covertly (e.g., as a watermark).

Permissions and preferences store 212 provides nonvolatile storage that includes a signature for each module that is required for a proper configuration of application program process 218. Typically, permissions and preferences store 212 includes signatures for numerous requirements for each of several proper configurations. In one implementation of store 212, for each configuration, each requirement is associated with a list of signature sets. Each list member (a signature set) is an alternative satisfaction of the requirement. For each configuration, store 212 may include permitted signatures or sets. In the absence of a complete preferred set, a permitted set may be used. In addition to sets that meet requirements, a permitted set may be used. Any particular members (e.g., a first member) of such a list may be expressly or impliedly designated as a preferred member. If a set is to be used to satisfy a requirement, then modules for every signature are typically loaded into staging store 206. A requirement is not met (and staging store 206 is incomplete) when less than all signatures of at least one set for that requirement are not present in staging store 206.

Identify software modules process 204 reads permissions and preferences store 212, determines the signatures corresponding to modules already loaded in stating store 206, and reads environment store 202 to determine the signatures of modules available there. If the modules already loaded in staging store 206 constitute a complete set, and no more preferred set of modules is available from environment store 202, identify software modules process 204 may omit requesting a transfer from transfer process 208. If the module corresponding to a required signature is not available from environment 202, an error condition is asserted. Otherwise, for each desired module as identified by its signature, identify software modules process 204 passes a request comprising the signature to transfer process 208.

Staging store 206 maintains in nonvolatile memory a list of signatures of modules that have been loaded from environment 202 by transfer process 208. Staging store may include other memory for some or all of the data of a loaded module. Preferably, when the data of a module is no longer needed by initialize process 210, memory used for storage of that data may be reused.

In another implementation, staging store 206 provides in nonvolatile memory a copy of environment memory 202. Identify software modules process 204 may compare some or all of staging store 206 to environment 202 and if different pass a general request for all of environment store 202 to be copied into staging store 206. For example, if a cyclic redundancy code read from (or calculated from) staging store 206 does not match a cyclic redundancy code read from (or calculated from) environment memory 202, a general transfer request is made.

Transfer process 208 reads environment store 202 and stores results in staging store 206. When updates are available from store 216, transfer process 208 reads update store 216 and writes results in environment store 202. Transfer process 208 may, prior to writing data in stores 202 or 206, apply data format conversions, calculate signatures, and store signatures with or apart from data written.

Initialize process 210 reads staging store 206, determines one or more suitable configuration values for use by application program process 218, and writes results in configuration store 214. Initialize process 210 may perform these functions when subsystem 104 is first coupled to environment memory 106 or at any time following a change in environment memory 106, for example, following an update write by transfer process 208 as discussed above. Initialize process 210 may reformat data read from store 206 prior to writing corresponding data into store 214. Initialize process 210 may read the state of application program process 218 from store 214 and defer updating configuration values until a suitable time to avoid unpredictable or unsuitable operations of subsystem 104. A configuration value may be any range or value that affects any operation or result of application program process 218, for example, an initial state, a parameter, a constant, a value for a variable, an instruction, an entry point, a pointer, a branch condition, a return value, a flag, or a message.

Update store 216 may be implemented on portable memory 120. Store 216 may include modules (with or without signatures) for transfer to environment store 202, or instructions or data for use by application program process 218. Data for use by process 218 may include additional or replacement signatures or sets of signatures for storage in permissions and preferences store 212.

Application program process 218 includes any conventional combination of processes for performing functions of a subsystem as discussed above. These functions may include surveillance, instrument monitoring, data capture, control, data processing, computation, analysis, graphics, reporting, advising, database management, and network communications. The inputs and outputs to perform these functions are not shown but may be implemented via communication with other subsystems 102 and 108 as discussed above.

A module may be stored in environment memory 106 (e.g., in store 202) as a set of components. Each component may include a data structure having fields, each field having a value. The arrangement of components may be contiguous or noncontiguous. When multiple modules include the same component, redundant copies of that component may be omitted from environment memory 106. A module may have a signature. Each component may have a signature. Components may be stored in any convenient arrangement, including, for example, as records of a database.

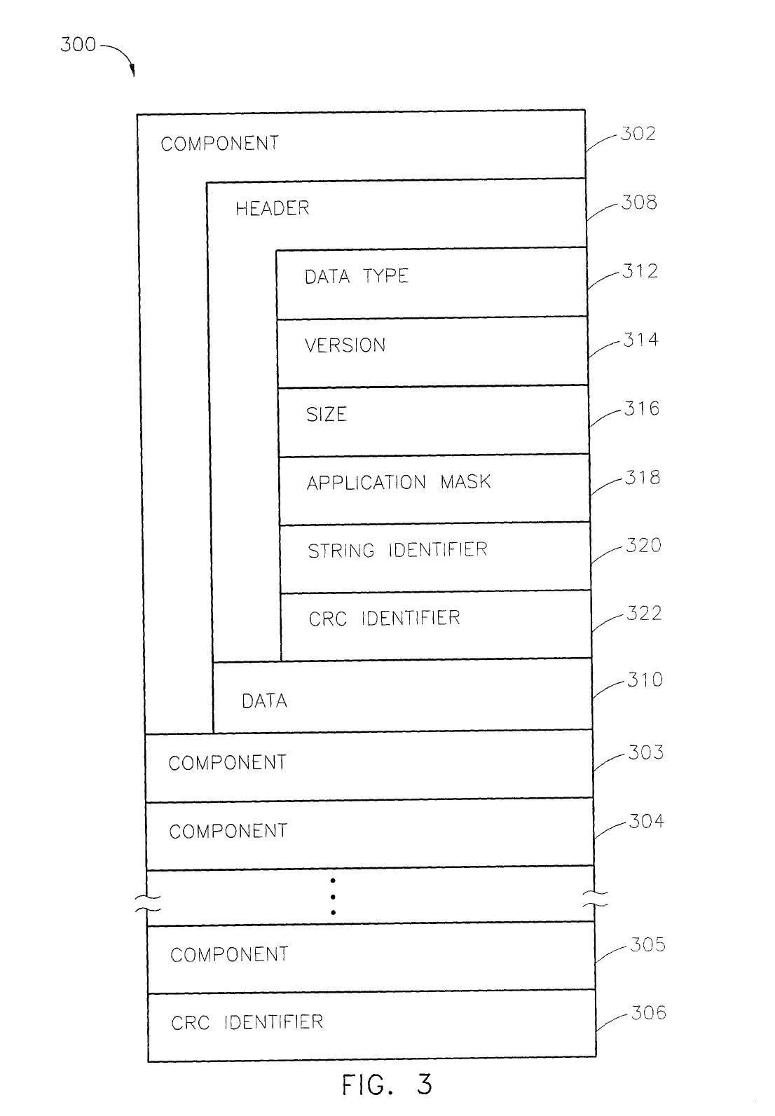

For example, data structure 300 of FIG. 3 includes several modules, each module having several components in any order. A first module may include components 302, 304 and 305. A second module may include components 303 and 305. The signature of each component may be stored with the component, for example, in a header field having a value for a precomputed cyclic redundancy code. Component 302, typical of others, includes a header 308 and a data field 310. A header includes fields having values that describe the component and the data portion of the component. Data may include values for reference (e.g., constants, or initial values as discussed above). Data may include portions that conform to standard formats such as Document Object Module (DOM), or Extended Markup Language (XML). Data may include portions that conform to a programming language for interpretation or execution (e.g., statements, instructions, objects, object code, or symbols (e.g., JAVA pCode)).

In the example implementation shown, header 308 includes fields as described in Table 1.

TABLE 1

| Field | Description |
|---|---|
| DATA TYPE 312 | An integer value that identifies the data field as con- |
| | taining data of a predefined type. For example, type |
| | values may include: 1 = message table rows; 2 = |
| | port table rows; 3 = conversion table rows; 4 = |
| | string table rows. |
| VERSION 314 | An integer value that describes the revision level of |
| | this component. |
| SIZE 316 | An integer value for the number of bytes occupied |
| | by the component. |
| APPLICATION | An integer value that describes a set of aircraft types |
| MASK 318 | that have been certified for hosting a system that |
| | would use this component. |
| STRING | A string value that describes the component. |
| IDENTIFIER 320 | |
| CRC IDENTIFIER | An integer value computed by a conventional |
| 322 | method from the value of the data field and, if |
| | desired, the header field. |

Data structure 300 may correspond to one module having components 302-305 and a module-level signature 306. Signature 306 may be a cyclic redundancy code calculated from all data of components 302-305. In an alternate implementation, signature 306 is an image-level signature, calculated from an entire image.

Use of the environment memory in combination with an application program reduces costs for deploying and maintaining a population of subsystems of the same general type. Consider, for example, that subsystem 104 is to be operable with a subsystem 108 of type A or type B and that both system configurations are to be certified by testing. If subsystem 104 is capable of operating with either type, the particular type may be identified in environment memory 106. Suppose that environment memory would include a module having components 302, 303, and 304 for type A and otherwise would include for type B a module having components 302, 303, and 305. If application program functions related to components 302 and 303 are independent of components 304 and 305, an application program may be certified for use with type B after tests limited to component 305. Consequently, testing of an application program for certified use with type B is simplified over prior art testing which may have involved testing all functions of the application program. When a new subsystem type C is defined for subsystem 108, testing of subsystem 104 to certify use with type C may be omitted when all components of the module or modules needed for type C have already been used with other certified configurations of the application program.

A subsystem may operate in a system according to various aspects of the present invention so that an application program performed by the subsystem accesses data across an application program interface. The application program interface (API) permits the application program to refer to data by identifying the data without identifying the subsystem that may be providing or receiving the data. The application program may request data from the API or provide data to the API. An environment memory coupled to the subsystem includes information sufficient to receive data from other subsystems, convert the received data into requested data, accept provided data from the application program, convert accepted data into data suitable for other subsystems, and send converted data to other subsystems. According to various aspects of the present invention, the subsystem is capable of operating in certified configurations with a wide variety of other subsystems in part because information sufficient for any particular configuration of other subsystems is provided by the environment memory and reprogramming of the subsystem is thereby avoided.

For example, a system 400, according to various aspects of the present invention, includes a subsystem 405 that cooperates with an environment memory 401 and other subsystems (herein called instruments) 404. System 400 is an example of a system of the type discussed above with reference to system 100 of FIG. 1. Subsystem 405 includes one or more processors operative as a ports managing engine 406 and an applications managing engine 408 that cooperate across an interface 407. The applications managing engine includes application programs 411 and an application program interface 460.

A ports managing engine performs initialization to effect an initial or a modified configuration for an application program and performs input/output functions to communicate between subsystems of a system. Initialization may be accomplished once upon installation of the subsystem or from time to time, for example, in response to activation of application programs or changes in the contents of environment memory. In a preferred embodiment, initialization occurs once in response to any application of primary power to the subsystem hosting the ports managing engine. For example, ports managing engine 406 includes initialize process 432, instrument I/O process 434, and interpret process 436. Ports managing process 406 further includes tables built in accordance with contents of environment memory 401. These tables include port table 442, message table 444, routing table 445, conversion table 446, string table 448, and data table 450. To build (or update) tables, ports managing engine 406 may allocate memory in subsystem 405 for each table, populate the tables with rows, combine rows from several components into the same tables, and link the tables for efficient access.

An applications managing engine performs, in turn, functions of an API and of each of one or more application programs. For fault tolerant purposes, it is preferred to operate each application program in a partition that is guaranteed processing time regardless of the operations being performed in other partitions. The applications managing engine may include conventional operating system functions for identifying and reporting access to memory (e.g., instruction fetch, data read, data write, stack or heap overrun) in violation of partitioning. For example, applications managing engine 408 performs functions of application programs 411 and API 460. In one implementation, ports managing engine 406 notifies applications managing engine 408 when power-on initialization is complete; and, in response, applications managing engine 408 starts each application program 409, 410 of programs 411. Ports managing engine 406 in this case may build tables according to the entire contents of environment memory 401.

In an alternate implementation, applications managing engine 408 notifies ports managing engine 406 of the operational I/O configurations of each application program. One way is for application managing engine 408 to build or use a list of permissions and preferences that describe all application program I/O configurations as discussed above with reference to store 212. Ports managing engine 406 builds tables to satisfy these configurations with reference to some or all of the contents of environment memory. Another approach is to expect each application program 409 to identify to the API what I/O configurations it may have at any time. In response to a request for an I/O configuration, ports managing engine 306 may initialize some or all of the tables to meet that configuration and notify applications managing engine 406 when initialization is complete. Consequently, application managing engine 406 may permit further operation of the requesting application program 409.

An API according to various aspects of the present invention presents an interface to each application program (e.g., multi-threaded) and presents an interface to a ports managing engine. The API may respond to requests for I/O configuration as discussed above; provide access by name to communication to and/or from other subsystems; and/or provide access by name to communication to and/or from other application programs. Communication occurs on a communication path that may include two or more ports and one or more links between the ports. Ports and links may be implemented in any conventional manner at the physical and/or logical levels. For example, API 460 includes register process 462, get handle process 464, and data I/O process 466. Each application program 409 and 410 may be written with knowledge of the names of data to be communicated between subsystems or application programs and with knowledge of API processes 462-466. By providing API processes in a library (not shown), application programs may be linked in a conventional manner to processes 462-466 by linking to the library (e.g., static or dynamic linking). When initialization is accomplished with the entire contents of environment memory 401, register process 462 may be omitted, simplifying application program development.

The API interface to a ports managing engine may include any combination of interprocess communication and shared memory. For example, interface 407 includes interprocess communication between register process 462 and initialize process 432; and includes shared access to string table 448 and data table 450. Any conventional interprocess communication technique may be used. When register process 462 is omitted, interprocess communication may be omitted, simplifying interface 407. Memory shared between ports managing engine 406 and API 460 may be implemented in any conventional manner (e.g., dual ported memory, pointers, and/or semaphores). Because string table 448 and data table 450 may be dynamically allocated, initialize process 432, get handle process 464, and data I/O process 466 may communicate in any conventional manner to implement initial sharing and sharing after any modifications to string table 448 and/or data table 450 (e.g., structural changes in response to I/O configuration requests).

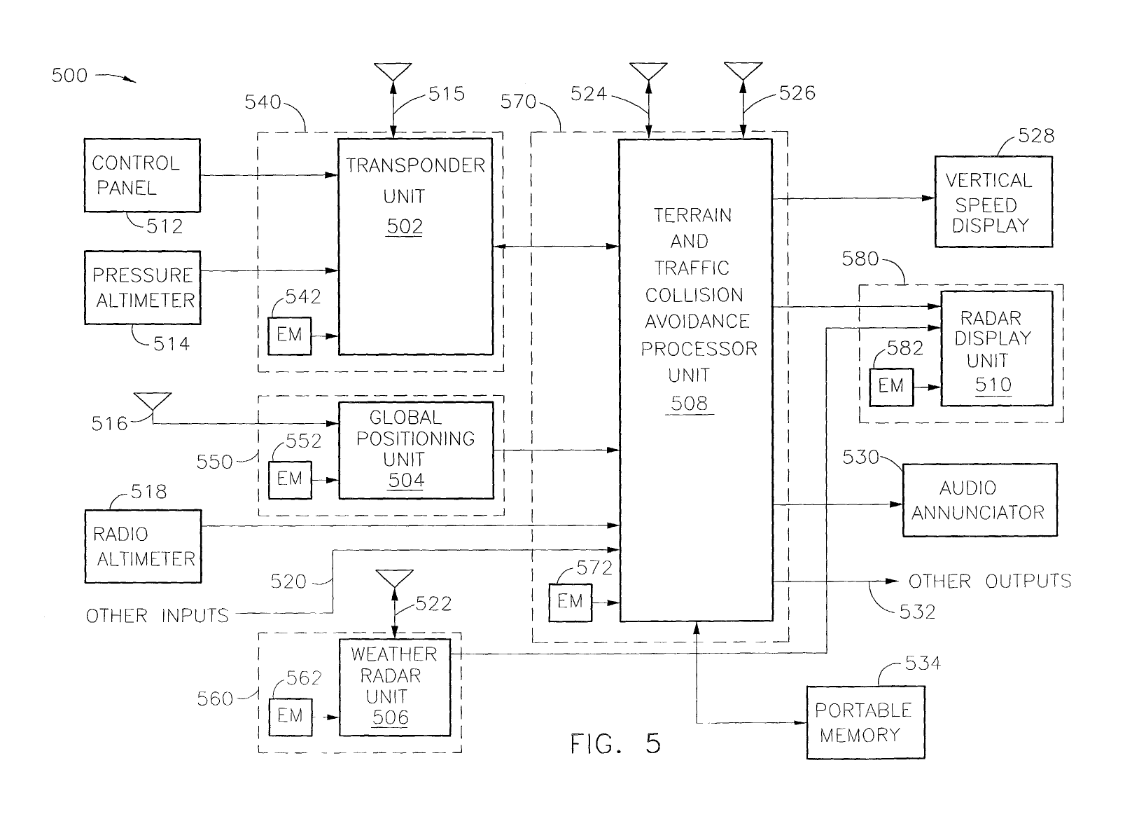

A port table includes any table having rows, each row providing parameters for initializing and/or accessing a port. A port may include an I/O buffer. The buffer may be any memory element or data structure (e.g., a register of any length, FIFO, array, stack, queue, ring buffer list, or linked list) for storing data received or to be sent. The contents of an I/O buffer may be formatted in any convenient manner including contiguous unformatted messages. Formatting for protocols for the interface between subsystems may include conventional hardware and/or software processes used to translate and format data between receiving from another subsystem and storing in the buffer and between depositing in the buffer and sending to another subsystem. For example, each row of port table 442 may include the fields described in Table 2. Port table rows may be fully specified with knowledge of system interconnections and without a complete knowledge of messages used in communicating via the port. Consequently, when system communication paths or wiring are revised (e.g., port function reassignment) without revision to the message level communication (e.g., adding a new message type to be processed) revision to the message table is avoided; and, when message level communication is revised without system communication paths or wiring changes, revision to the port table is avoided. For example, each row of port table 442 presents a description of a communication path from subsystem 104 to other subsystems 102, 108. As another example processor unit 508 of FIG. 5 would read environment memory 572 and form a port table in its internal memory to include at least one row for each communication path: 502-508, 504-508, 518-508, 520-508, 508-528, 508-510, 508-530, and 508-532. From the point of view of an application program running in processor unit 508, a port description is sufficient for describing a communication path.

TABLE 2

| Field of port | |
|---|---|
| table 442 | Description |
| Port | A symbolic name for this port. A symbolic port name is |
| identifier | used for field entries stored in environment memory 401, |
| | for example, in message table rows, conversion table rows, |
| | and routing table rows. |
| Port style | A code describing the signaling protocols for this port, for |
| | example, (1) ARINC 429; (2) +/− 12 volt analog; (3) shared |
| | memory. The shared memory style may indicate that the |
| | message table entry that points to this port table entry is |
| | for interprocess communication or special processing. |
| | Interprocess communication may include, for example, |
| | applications 409 and 410 sharing access to the same part |
| | of data table 450. Special processing may involve period- |
| | ically applying operations from conversion table 446 for the |
| | benefit of one or more application programs 411. |
| Initialization | One or more binary values transferred to the initialization |
| value | register(s) to configure or activate a mode of I/O operations |
| | (e.g., for communication between subsystems). |
| Initialization | Identifiers of one or more addresses of registers to be set |
| register | with initialization values. The identifiers may be direct or |
| | indirect addresses (e.g., symbolic and subject to linking, |
| | or subject to mapping). |
| Base/Offset | Identifiers of one or more addresses of registers describing |
| register | the current configuration and state of the port. The identi- |
| | fiers may be direct or indirect addresses (e.g., symbolic |
| | and subject to linking, or subject to mapping). |
| Message | Identifiers of one or more addresses of registers where |
| queue | messages may be accessed for input (received messages) or |
| register | for output (messages to be sent). The identifiers may be |
| | direct or indirect addresses (e.g., symbolic and subject to |
| | linking, or subject to mapping). |
| Message | Identifiers of one or more addresses of registers where |
| header | messages received or to be sent are described. When the |
| | message includes its own description (e.g., message in- |
| | cludes a header describing length), this field may be |
| | omitted. |
| LRU | A reference to a string table row that identifies a system |
| | name for the subsystem that uses this port for communica- |
| | tion. For example, an entry in environment memory 572 |
| | may identify a port for communication with global posi- |
| | tioning unit 504 by the name “GPS1”. May contain a |
| | symbolic row reference prior to linking and after linking |
| | contain a physical memory address of a corresponding row |
| | of the string table. |

In an alternate implementation, a port table row may further include a pointer to a message table row or to the first of a group of message table rows.

A message table includes any table having rows, each row describing message content. Message content may be described by providing parameters for one process for receiving or sending messages of a particular type. A portion of data table 450 may be modified in response to data received in one or more messages and in response to parameters of one or more message table rows. Parameters may identify a portion of data table 450 to be modified (e.g., rewriting the value of a variable, setting a flag, appending data to a list, or enqueueing data into a linked list). A message may be formed and/or sent in response to a portion of data table 450 and in response to parameters of one or more message table rows. Parameters may identify the portion of data table 450 to be prepared for sending or sent (e.g., reading the value of a variable, reading a flag, removing data from a list, or dequeueing data from a linked list). For example, each row of message table 444 may include the fields described in Table 3. Sending and receiving may implement instrument I/O or interprocess communication.

TABLE 3

| Field of | |
|---|---|
| message | |
| table 444 | Description |
| Port | A pointer to a port table row. May contain a symbolic row |
| identifier | reference prior to linking and after linking contain a physi- |
| | cal memory address of a corresponding row of the port |
| | table. |
| Message | A value that identifies the type of a message in a system |
| identifier | where several message types may be communicated via the |
| | same port. In a system having only one message type, this |
| | field may be omitted. Message types may be encoded. The |
| | value of this field may be the encoded version or the un- |
| | encoded version of the type value. When the string table is |
| | used for encoding, this field may contain a pointer to a |
| | string table row. For example, an ARINC 429 label identi- |
| | fies a message type. The label may be stored in the string |
| | table and a pointer to the label stored in this field. May |
| | contain a symbolic row reference prior to linking and after |
| | linking contain a physical memory address of a correspond- |
| | ing row of the string table. |
| Source/ | Describes whether the port is a source of data that is re- |
| Destination | ceived by subsystem 405 or a destination of data sent from |
| indicator | subsystem 405. |
| (SDI) | |
| Port polling | A value that specifies a period between polling or a polling |
| rate | repetition rate as either a minimum or a maximum. In an |
| | alternate implementation, minimum and maximum specifi- |
| | cations are included with the addition of a suitable field. |
| | For a port of the shared memory style, the polling rate |
| | specifies a schedule for periodic processing related to the |
| | shared memory (e.g., clearing, setting to a constant, cal- |
| | culating one value from others, testing for consistency with |
| | other values, validating, or sampling for data analysis). |
| Frame offset | One or more values of parameters used for sending a |
| | repetitive message (e.g., updating a value in another sub- |
| | system). In a system having communication organized as a |
| | recurring primary frame (e.g., 1 per second) followed by a |
| | known number of secondary frames (e.g., 20) used for one |
| | or more message updates (e.g., 5 subframes equally spaced |
| | for updating current altitude), a frame offset value may be |
| | coded as zero for use of subframes 0, 4, 8, 12, 16; one for |
| | use of subframes 1, 5, 9, 13, 17; and so on. |
| Message size | A length (e.g., in bytes) or a coded value specifying one of |
| | a set of standard message lengths. |
| API | Identifies a portion of data table 450 allocated for the value |
| parameter | of an API parameter corresponding to the port and message |
| handle | identified to this row. In an alternate implementation, the |
| | handle may identify a process (e.g., an object that owns that |
| | portion of data table 450) and one or more arguments (e.g., |
| | operations on the data table to be performed for the |
| | message such as read, write, write if valid, and/or notify). |
| | May contain a symbolic row reference prior to linking and |
| | after linking contain a physical memory address of a cor- |
| | responding row of the data table. |
| API para- | A pointer to a string table row that provides a name for the |
| meter name | parameter. The name may be used by application programs |
| | for access to data table 450. May contain a symbolic row |
| | reference prior to linking and after linking contain a physi- |
| | cal memory address of a corresponding row of the string |
| | table. |
| API para- | A coded value for distinguishing similarly named para- |
| meter style | meters. For example, style may indicate (a) binary, floating |
| | point, character string, array, or other conventional data |
| | organizations; (b) membership in a set of similar parameter |
| | values such as maximum, minimum, relative staleness, |
| | FIFO position; or (c) usage such as shared/private use of |
| | the parameter. |
| API para- | An identifier of the application program and/or partition |
| meter owner | having permission to write to this API parameter. Several |
| | application programs and/or partitions may have read |
| | authority. |
| Filter | When received values are to be subject to averaging, |
| specification | weighting, validation, sampling, comparison, or special |
| | handling, values in this field provide arguments to a general |
| | purpose process so that the general purpose process (e.g., |
| | a multi-threaded routine) properly analyzes received values |
| | for this API parameter. The result of analysis may affect |
| | data table 450 at one portion (e.g., current filtered result) |
| | or several portions (e.g., current, minimum, maximum, and |
| | filtered result). |
| Conversion | When a received message is to be subject to further pro- |
| opcode | cessing, a conversion opcode may be entered in this field. |
| | The conversion operations may proceed according to the |
| | value of a conversion argument. If the received message |
| | is to be subject to a series of conversion opcodes, this field |
| | may provide a “redirection” opcode and the conversion |
| | argument field may provide a pointer to a row of the |
| | conversion table having the first opcode of the series. |
| Conversion | One or more values used with the conversion opcode field; |
| arguments | or a pointer to a row of the conversion table. May contain a |
| | symbolic row reference prior to linking and after linking |
| | contain a physical memory address of a corresponding row |
| | of the conversion table. |

A routing table includes any table having rows, each row for identifying one or more processes for receiving or sending messages of a particular type. When a message is received and the message includes information subject to several processes (e.g., a message having unrelated flags and values), a routing table row may identify the first of a series of message table rows, each message table row identifying one process to which the message data (or part of the message data) is subject. When a message is to be composed for sending and the message is to include information from several processes (e.g., read processes or analysis processes), a routing table row may identify the first of a series of message table rows, each message table row identifying one process providing a portion of the data to be sent. In each series of processes, an earlier executing process may prepare data used by a later executing process (e.g., unpacking the initially received format of a message, or formatting a collection of data into final form). For example, each row of message table 445 may include the fields described in Table 4. Sending and receiving, as discussed above, may implement instrument I/O or interprocess communication.

A routing table may be constructed as a result of an analysis of message table rows. When several message table rows exist for the same message (and port) as identified by message identifier (and further by port identifier), these message table rows may be grouped (e.g., made consecutive); a row appended to the routing table pointing to the first row of the group; and the routing table row revised to include a number of message table rows to be included in the group.

In alternate implementations, suitable routing table rows may be included in environment memory with symbolic referenceces to message table rows. Further, grouping may be alternatively accomplished by indexing for sequential access. In yet another implementation, message table rows are made part of a group by a conventional linked list technique. References from one message table row to another may be symbolic references prior to linking (e.g., as stored in environment memory).

TABLE 4

| Field of | |
|---|---|
| routing | |
| table 445 | Description |
| Port | Same as corresponding message table field. |
| identifier | |
| Message | Same as corresponding message table field. |
| identifier | |
| Series | A pointer to a first row of the message table. May contain a |
| start | symbolic row reference prior to linking and after linking con- |
| | tain a physical memory address of a corresponding row of |
| | the message table. |
| Series | An integer number of rows of the message table to process for |
| length | the same message. |
| Message | A counter that is incremented for system diagnostics. |
| activity | |
| counter | |
| Message | A code for indicating whether the last received message was |
| validity | valid. This code may be set by a conversion opcode. The code |
| status | may represent one of a set of statuses: normal operation, no |
| | data to be computed, functional test, and failure. |
| Raw | Data received in a message or data to be sent in a message. If |
| message | message length varies, this field may identify a portion of |
| | data table 450 allocated for a raw message. May be used by |
| | built in test equipment (BITE) to report the message that is |
| | associated with an unexpected condition. |
| Failure | BITE may include a process that sets this field value (e.g., a |
| reported | flag) in response to detecting an unexpected condition |
| | associated with reception, processing, analysis, or sending of |
| | the message identified by this row. By setting this flag, mul- |
| | tiple reports for the same error are avoided. |

A conversion table includes any table having rows, each row describing an operation to be performed for communication between subsystems or between processes, as discussed above.

TABLE 5

| Field of | |
|---|---|
| conversion | |
| table 446 | Description |
| Port | Same as corresponding message table field. |
| identifier | |
| Message | Same as corresponding message table field. |
| identifier | |
| Conversion | Identifies a process linked to the API for performing an |
| opcode | operation. Operations are described below. |
| Conversion | One or more values used with the conversion opcode field, |
| argument | for example, for defining a relative jump forward, for |
| | supplying a floating point number, or for identifying a |
| | variable or API parameter. |

An opcode includes any identifier (e.g., a code or a process identifier) that when used in a series specifies operations to perform so as to validate, analyze, sample, convert, select, receive, or send data in accordance with a result of the series of operations. In a preferred implementation, such operations are performed with reference to data of or for a particular message and message type. For example, a series of opcodes may be associated with (e.g., identified by) a row of a message table. A multiplicity of such series may be associated with (e.g., identified by) a row of a routing table. Each series of operations constitutes a program. Execution of such programs may be by interpretation, or direct execution, though interpretation is preferred for simplicity of preparing and combining components. Interpretation may provide a model of computation similar to a calculator, general purpose computer (e.g., assembly language) or arithmetic logic unit (e.g., state machine microcode). A preferred implementation includes interpretation according to a model of a calculator using a reverse polish notation. According to various aspects of the present invention, several program control operations are not implemented to avoid undesirable failure modes. For example, opcodes for jump backwards, loop, subroutine call, push onto a stack, pop from a stack, block move, and block copy operations are not implemented to avoid failure modes such as infinite repetition, infinite recursion, and improper access to memory. Opcodes may include operations described in Table 6.

TABLE 6

| Operation | Opcodes and Descriptions |
|---|---|
| Recall | GETAPI reads a portion of data table 450 into a register of the |
| | model for further computation. Conversion arguments may |
| | identify the portion of data table 450. GETVAR reads a |
| | value from any variable of ports managing engine 406 into a |
| | register of the model. |
| Store | SETAPI writes from a register of the model into a portion of |
| | data table 450. Conversion arguments may identify the portion |
| | of data table 450. SETVAR writes from a register of the |
| | model into any variable of ports managing engine 406. |
| Constants | LITERAL pushes immediate data into the model's register set. |
| Arithmetic | RADD, RSUB, RMUL, RDIV perform addition, subtraction, |
| | multiplication, and division respectively on registers of the |
| | model. E_TO_X performs an exponential function. Any |
| | arithmetic function of a conventional RPN calculator may be |
| | implemented. |
| I/O | IN reads raw message data from a row of the routing table |
| | or from a port into register(s) of the model. When a message |
| | is longer than the destination register(s) can contain, con- |
| | version arguments may identify an offset and size of a portion |
| | of the message. OUT writes raw message data into a row of |
| | the routing table or to a port from register(s) of the model. |
| | When a message is longer than the destination register(s) can |
| | contain, conversion arguments may identify an offset and size |
| | of a portion of the message. INAPI (or OUTAPI) performs |
| | like IN (or OUT) except the input (output) is stored in |
| | (recalled from) an API parameter named in a conversion |
| | argument. |
| Branch | Relative jump conversion codes include JMP, JNZ, JZ, JGT, |
| | JGE, JEQ, JLE, JLT, JF, JT that perform comparison of one |
| | or more registers of the model and respectively jump uncon- |
| | ditionally, jump if not zero, jump if zero, jump if greater than, |
| | jump if greater than or equal, jump if equal, jump if less than |
| | or equal, jump if less than, jump if false, and jump if true. |
| | Conversion arguments may specify a number of opcodes to |
| | skip forward for the jump (e.g., number of rows of conversion |
| | table 446). |
| Transfer | Either RETURN or INVAL may mark the end of a series of |
| of pro- | opcodes, RETURN indicating proper operations were per- |
| gram | formed and suitable results obtained; and, INVAL indicating |
| control | that the operations or the results from the series of opcodes |
| | is to be considered invalid. INVAL may indicate that the data |
| | or conditions prior to beginning the series were invalid. RE- |
| | DIRECT may appear only in a conversion opcode field of a |
| | row of message table 444. REDIRECT indicates that the con- |
| | version argument is a pointer to a row of conversion table |
| | 446. |

A string table includes any table having rows, each row associating a reference code value with an unencoded value. The unencoded values may be used where more human readability is desired or where information is to be hidden. For example, memory physical addresses (e.g., of tables 442-450, and of paths for interprocess communication) and port physical addresses (e.g., registers) may be hidden from applications managing engine 408 and/or application programs 411. By hiding physical addresses, ports managing engine 406 may freely allocate memory physical addresses and configure operation with port physical addresses so that application programs may operate without being revised when such physical addresses differ from one installation to the next. Encoding may facilitate linking which involves the substitution of reference codes for unencoded values. Linking may be used to realize advantages in storing, transferring, and referring to values stored at memory physical addresses and port physical addresses. For example string table 448 may be indexed for access by name or by reference code.

TABLE 7

| Field of | |
|---|---|
| string | |
| table 448 | Description |
| Name | A character string for human readability that may be used as |
| | any identifier discussed above. For example, an LRU name, a |
| | message identifier (e.g., ARINC 429 label), an API parameter |
| | name, or an application program name. |
| Type | A code describing what the name refers to. For example, |
| | values may be assigned as follows: (1) an LRU name, (2) a |
| | port identifier, (3) a message identifier, (4) an API parameter |
| | name, (5) application program name, and (6) tag as discussed |
| | below. In an implementation where all names are unique or |
| | where the names are all of one type (e.g., API parameter |
| | names), the type field may be omitted. |
| Reference | The reference code field may be omitted from rows stored in |
| code | environment memory 401. The reference code field is given a |
| | value (or substituted value) by ports managing engine 406. |
| | For a name field value referring to a message (e.g., a message |
| | identifier), the reference code may point to a row of message |
| | table 444 (e.g., for output) or data table 450 (e.g., for input). |
| | For a name field value referring to an API parameter (e.g., |
| | an API parameter name), the reference code may point to a |
| | row of message table 444 or to the API parameter handle field |
| | of that row. The reference code field may be rewritten to |
| | substitute a memory physical address (e.g., of the beginning |
| | of a table row) or port physical address for a row number |
| | (e.g., within a component) or relative address of a row. In |
| | an implementation where port identifier and message identifier |
| | are combined to form a tag and tables are indexed on values |
| | of the tag (e.g., the tag used as a key when accessing a first |
| | row of a conversion series or group of message table rows), |
| | the name field may provide the combined port name and |
| | message name; and, the reference code may supply the tag |
| | value. |

A data table provides storage for API parameters and may provide storage for ports managing engine variables. Each API parameter and variable may constitute a row of the data table. In one implementation, port table 442, message table 444, routing table 445, conversion table 446, and string table 448 are composed of rows of uniform length respectively (e.g., all rows of port table are of a first length and all rows of message table are of a second length). Implementation of such tables may use conventional techniques such as an array of records. Data table 450, on the other hand, may provide storage for API parameters and variables of any suitable length and organization. Because data table 450 need not be implemented for sequential access to all its contents, the form in memory of data table 450 may resemble a conventional memory workspace having no apparent structure, order, or embedded description of contents. As ports managing engine 406 allocates memory physical addresses for various purposes, ports managing engine 406 may initialize and update a mapping table (not shown) for optimization of references to data table rows.

An initialize process, according to various aspects of the present invention, includes any process that determines the content of a set of tables for communication between subsystems, table content being responsive to data from a memory external to the subsystem. An environment memory may provide such data, preferably in rows that are combined and optimized by the initialize process. For example, initialize process 432 is activated by ports managing engine 406 on detection of power applied, an operator request, or a change in environment memory contents. Detection of these events may be accomplished in any conventional manner. Initialize process 432 allocates internal memory for each of tables 442-450; reads components from environment memory 401, or reads staging store 206 as discussed above; determines from each component (e.g., by data type 312) the type of table the rows in data 310 are intended for; appends rows to tables as intended; for each table, assures table rows as they appear in tables 442-450 have no occurrences of predetermined types of errors; and for each table, links field values to implement symbolic references. When initialize process 432 has completed these functions, control is returned to ports managing engine 406.

In an alternate implementation, initialize process 432 may perform the above functions to establish a minimum configuration and thereafter respond to requests for configurations as discussed above with reference to register process 462.

An instrument I/O process, according to various aspects of the present invention, conducts communication between subsystem 405 and other subsystems according to parameters describing ports (e.g., a port table) and parameters describing messages (e.g., a message table). An instrument I/O process may conduct communication according to polling or interrupts. For example, instrument I/O process 432 in one implementation may respond to an interrupt from an interface circuit (e.g., interrupt on message received, on message sent, on service required for optimal communication, or on lapse of a timer). In another implementation, process 432 may poll ports by reading port table 442. In yet another implementation, process 432 may poll ports by reading message table 444 and following links to port table 442. In still another implementation, a combination of these techniques may be used and a combination for input may differ from a combination for output. Further, instrument I/O process 432 may be responsive to interprocess communication with interpret process 432 to perform functions including polling interpret process 436 for message data to send, responding to an interrupt from process 436 when a message is ready to be sent, interrupting process 436 when message data is received, or responding to polling from process 436 as to availability of message data received.

Conducting communication for inputs may include reading message data from I/O buffers (or shared memory for interprocess communication); determining a list of dispositions for this message type; determining in each disposition whether message data is to be stored in shared memory to be available to application programs via the API, or is to be subject to processing; if the former, then storing the message data (possibly after a simple operation on the message data); and if the later, passing the message data to an interpret process where a series of operations may be performed. For example, process 434 may read rows of message table 444 in series and for each row having source designated in an SDI field and having a lapsed polling period (herein called the ready row), may read message data from the port (e.g., I/O buffer or queue) described by the port table row referred to from the ready row. If the read message data corresponds in type to the message identifier of the ready row, then polling has been satisfied and the polling time may be reset. Process 434 may repeatedly read per the ready row and process messages until the message of the type described in the ready row is processed or the I/O buffer is empty. If the I/O buffer is emptied, the polling time may be reset. Process 434 then continues (indefinitely) the serial search of message table 444, looping back from the last row to the first, and processing ready rows as discussed above.

When a message has been read from the I/O buffer, an instrument I/O process according to various aspects of the present invention may initiate a series of processes each of which may use a portion of the message data. For example, process 434 uses the port identifier and the message identifier of the port read and of the message read from that port as an index into routing table 445. Processing of the received message data then proceeds as directed by the first message table row identified by routing table 445 (e.g., the Start series field) and continues for a suitable number of rows (e.g., the Series length field). If routing table 445 has no entry, the message may be ignored.

Each message table row directs process 434 to perform one of the following functions: (a) determining that the conversion opcode field specifies “store” and therefore storing message data as specified by the conversion argument (e.g., an API parameter of data table 450); (b) determining that the conversion opcode specifies a simple operation and therefore performing that operation prior to storing as discussed in (a); or determining that the conversion opcode field specifies “redirect” and therefore passing the message data (or a reference to it) to interpret process 436 for processing. As a consequence of these operations, the value of one or more API parameters is responsive to the received message data.

Conducting communication for outputs may include determining whether a schedule dictates that a message should be prepared and sent; determining whether one or more preparations of message data have been made; and writing message data from shared memory to a suitable port (or to another portion of shared memory for interprocess communication). For example, process 434 may read rows of message table 444 in series and for each row having destination designated in an SDI field and having a lapsed polling period (herein called the ready row) may determine a list of preparations. When a message is to be prepared, an instrument I/O process according to various aspects of the present invention may initiate a series of processes each of which may prepare a portion of the message data. For example, process 434 uses the port identifier and the message identifier from the ready row as an index into routing table 445. Processing resulting in message data then proceeds as directed by the first message table row identified by routing table 445 (e.g., the Start series field) and continues for a suitable number of rows (e.g., the Series length field).

Each message table row directs process 434 to perform one of the following functions: (a) determining that the conversion opcode field specifies “recall” and therefore recalling message data as specified by the conversion argument (e.g., an API parameter of data table 450); (b) determining that the conversion opcode specifies a simple operation and therefore performing that operation before recalling as discussed in (a); or determining that the conversion opcode field specifies “redirect” and therefore passing control to interpret process 436 for preparing message data prior to recalling as in (a).

As a consequence of these operations, one or more output operations may be performed either by instrument I/O process 434 after recalling (or redirection followed by recalling); or by conversion opcodes (e.g., interpret process 436). Instrument I/O process may send recalled message data via the port described in a row of port table 442 that is identified in the ready row. Interpret process 436 may send message data by performing an OUT opcode resulting in sending message data to a port described in a row of port table 442 that is identified in a conversion argument associated with the OUT opcode. Sending by process 436 to one or more ports may precede sending by process 434.

An application program may access shared memory, according to various aspects of the present invention, with knowledge merely of the name of an API parameter. Significantly, the application program does not need to know what path, port, or subsystem is providing the requested API parameter. Consequently, an application program may be developed, tested, and certified as operable regardless of which of several particular paths, ports, and subsystems may be available in a particular installation. An installation may provide more than one path, port, and/or subsystem for a single API parameter, source selection being accomplished, for example, by interpretation of conversion opcodes. For example, system 400 permits applications 411 to access data table 450 by using an API parameter handle obtained from a get handle process.

A get handle process, according to various aspects of the present invention, provides an API parameter handle in response to a request that includes an API parameter name. For example, get handle process 464 uses the API parameter name provided in a request from application program 409 as a value for indexing into string table 448. String table 448, having a row with the requested API parameter name, may provide an API parameter handle. Process 464 provides that handle to application program 409. Application program 409 may make numerous requests for handles in an initialization process and then refer to those handles throughout its operation. Alternately, ports managing engine may from time to time modify the handle value in string table 448 and, consequently, application program 409 must request a current handle prior to each access to data table 450. Portions of data table 450 may be designed for either or both of these access methods. Use of the handle may be limited and conditions of use may be provided with the handle or enforced during development of an application program 409 or 410. Use may include, for example, read access, write access, access to create, access to delete, or write with semaphore for shared write access.

A data I/O process, according to various aspects of the present invention, transfers data between shared memory and an application program in accordance with a handle. For example, data I/O process 466 receives data and a handle from application program 409 to write a new value into an API parameter of data table 450 as identified by the handle. Data I/O process 466 receives a handle from application program 409 and provides to application program 409 the value of an API parameter of data table 450 as identified by the handle. In a preferred implementation, the handle is a physical address of the API parameter value in data table 450 as allocated during initialization. In an alternate implementation, data I/O process 466 includes a number of processes (e.g., objects) that own particular API parameter values; and, the handle identifies (e.g., with an accompanying argument) the process (e.g., object or behavior) to invoke to accomplish the intended data transfer.

The system discussed above may be operated in an aircraft as avionics. The application program of a subsystem may perform avionics functions including, for example, navigation, flight management, mission command, communication, control, or collision avoidance. For example, an air traffic and terrain collision avoidance system for use on a conventional aircraft, according to various aspects of the present invention, includes one or more environment memories and one or more replaceable subsystems as discussed above. An air traffic and terrain collision avoidance system may include conventional structures and functions as specified in DO-185A (as to traffic collision avoidance) and as specified in ARINC 900 (as to terrain avoidance). System 500 as a whole includes structures and performs methods as discussed in general above; and, includes portions that individually include structures and perform methods as discussed in general above.

For example, transponder unit 502 may be a replaceable subsystem installed in tray 540 to connect to environment memory 542. Environment memory 542 may include modules having components for describing functions of system 500 (e.g., available power for transmitting at various altitudes) and interfaces to other portions of system 500 (e.g., type of antenna 515 and type of processor unit 508). In an alternate implementation, a conventional transponder and tray are used; and, environment memory 542 is omitted.

Global positioning unit 504 may be a replaceable subsystem installed in tray 550 to connect to environment memory 552. Environment memory 552 may include modules having components for describing functions of system 500 (e.g., accuracy for reporting position to processor unit 508, or sensitivity of receivers in unit 504) and interfaces to other portions of system 500 (e.g., type of processor unit 508 and command sequences to be used with processor unit 508). In an alternate implementation, a conventional global positioning unit and tray are used; and, environment memory 552 omitted.

Weather radar unit 506 may be a replaceable subsystem installed in tray 560 to connect to environment memory 562. Environment memory 562 may include modules having components for describing functions of system 500 (e.g., type of antenna 522 and manner of updating the display unit 510) and interfaces to other portions of system 500 (e.g., type of display unit 510 and command sequences to be used with it).

Radar display unit 510 may be a replaceable subsystem installed in tray 580 to connect to environment memory 582. Environment memory 582 may include modules having components for describing functions of system 500 (e.g., number of sources of information to be displayed and manner of updating the display unit 510) and interfaces to other portions of system 500 (e.g., type of display unit 510, type of processor unit 508, and type of weather radar unit 506).

Terrain and traffic collision avoidance processor unit 508 may be a replaceable subsystem installed in tray 570 to connect to environment memory 572. Environment memory 572 may include one or more modules having components for describing functions of system 500 (e.g., aircraft performance capabilities to pull up, fuel consumption, or weight) and interfaces to other portions of system 500 (e.g., type of antennas 524 (e.g., directional) and 526 (e.g., omnidirectional), type of transponder unit 502, type of global positioning unit 504, type of radio altimeter 518, type of weather radar unit 506, type of vertical speed display 528, type of radar display unit 510, type of audio annunciator 530, and/or description of discrete and bus inputs 520 and discrete and bus outputs 532).

In operation, system 500 performs as follows after initialization. During initialization, each subsystem that has been installed at an interface having environment memory may conditionally read its environment memory as discussed above and operate in accordance with data read from the environment memory. The system then continuously determines the own aircraft data including altitude, velocity, and bearing; interrogates other aircraft to determine other aircraft altitude, velocity, and bearing; determines whether a threat of collision with other aircraft exists with reference to own aircraft altitude, velocity, and bearing and with other aircraft altitude, velocity, and bearing; displays own aircraft data including altitude, velocity, and bearing, and at least the altitude and bearing of other aircraft; determines own aircraft position; displays (e.g., on the radar display) a terrain map for the own aircraft position; determines whether a threat of collision with terrain or other aircraft exists with reference to the terrain map; and alerts the crew of threats of collision with other aircraft or with terrain. A subsystem having internal nonvolatile memory may determine that environment memory should be read into the internal nonvolatile memory by comparing a signature of the internal nonvolatile memory with a signature of the environment memory. The signatures calculated and compared may be image-level, module-level, and/or component-level. Reading environment memory into internal nonvolatile memory may be avoided when corresponding calculated and read signatures match.

In one implementation, environment memory 572 includes one module having an overall signature. The module comprises numerous components, each component comprising a respective signature. Preferably, each signature includes a value of the type known as a cyclic redundancy code. For each component, identification and validation of the component are simplified by maintaining a physical relationship between the component and its signature. The relationship may be between the signature and the component data, for example, storing the component's data contiguous with a header that includes the signature maintains a physical relationship between the signature and the data of the component. The relationship may be between the signature and a combination of the component data and header information, for example, calculating the signature on the basis of the component data and associated header information maintains a relationship between the header information and the component data.

A component may be validated at any time by calculating a signature; comparing the calculated signature with the signature maintained in association with the component; and considering the component validated when the signatures match. The signature of a component may serve to identify the component for purposes of testing or identifying the component, an aggregation of components, a module, an aggregation of modules, or an environment memory.

A signature may be used for validation and for identification of the data associated with the signature. By identifying and/or validating components already transferred from environment memory, a decision based on identification and/or validation may result in identifying, validating, and transferring one or more components from environment memory. A method for conditionally transferring components from environment memory may assure that the components used for subsystem operations are the best available.

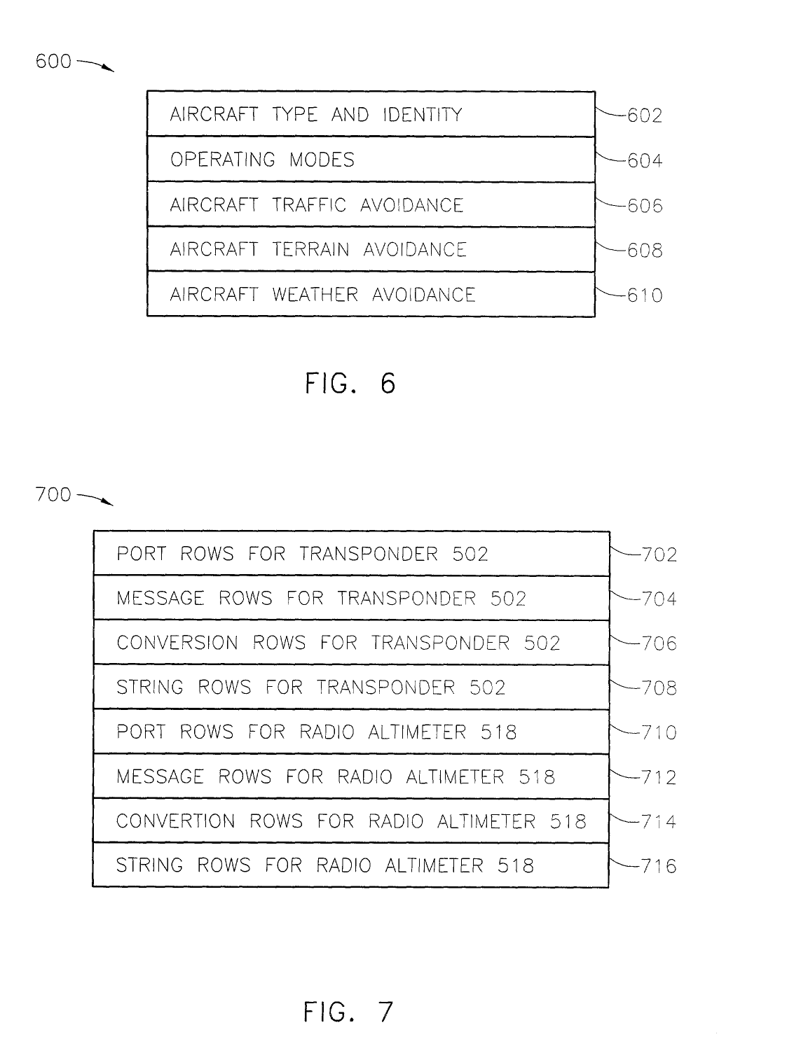

The contents of an environment memory may include groups of modules, modules, and components, as discussed above. For example, an environment memory 572 may include, among other things, groups of modules as shown in memory map 600 of FIG. 6. Groups of modules, modules, and components may be contiguous or arranged in any arbitrary manner including intermingling components of one module or group with another. For example, as each new group or module is stored, any components already stored need not be stored in duplicate. Memory map 600 includes in any order aircraft type and identity group 602, operating modes group 604, aircraft traffic avoidance group 606, aircraft terrain avoidance group 608, and aircraft weather avoidance group 610. Aircraft type and identity group 602 may include modules describing, for example, aircraft body style, fuel capacity, weight, burn rate, and maneuvering capability. Operating modes group 604 may include modules describing parameters for operation of system 500 and other systems installed on the aircraft. Aircraft traffic avoidance group 606 may further describe the aircraft's capabilities to be relied upon for traffic avoidance, including for example, descriptions of other systems (flight management, inertial navigation, or formation flight controls) and intersystem communication if any, aircraft climbing thrust and weight change for various fuel burn rates at various temperatures and altitudes. Aircraft terrain avoidance group 608 may further describe the aircraft's capabilities to be relied upon for terrain avoidance, including for example, system interconnections for obtaining time of day, coordinates of current position, and time and distance profiles for alerts. Aircraft weather avoidance group 610 may further describe the aircraft's capabilities to be relied upon for avoiding wind sheer, turbulence, and other adverse conditions including for example, system interconnections for radar imaging, and time and distance profiles for alerts.

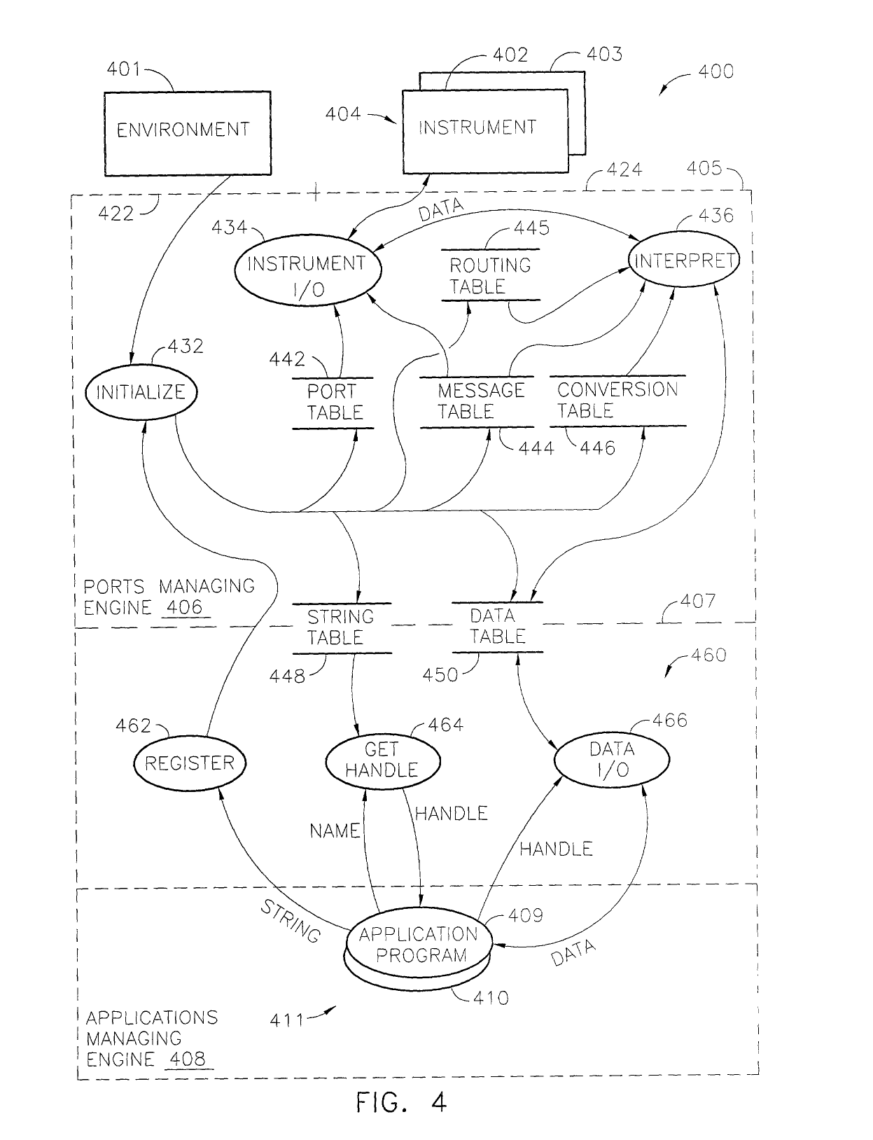

The contents of any of the components discussed with reference to FIG. 6 may include rows for various tables as shown in memory map 700 of FIG. 7. Headers of components are not shown for clarity of presentation. The contents of a group of modules may include components, as discussed above, each component having zero or more rows to be included in tables of the type discussed above with reference to FIG. 4. For example, aircraft terrain avoidance group 608 may include, among other things, components as shown in memory map 700 of FIG. 7. Memory map 700 may comprise eight components: port rows 702 for transponder 502, message rows 704 for transponder 502, conversion rows 706 for transponder 502, string rows 708 for transponder 502, port rows 710 for radio altimeter 518, message rows 712 for radio altimeter 518, conversion rows 714 for radio altimeter 518, and string rows 716 for radio altimeter 518. Alternatively, memory map 700 may be implemented as one component for each instrument. For example, pluralities of rows 702-708 for transponder 502 may constitute one component or be divided across several components. Pluralities of rows 710-716 for radio altimeter 518 may constitute one component or be divided across several components. Rows for the same type of table may be combined in a component or divided across several components, for example, port rows 702 and 710.

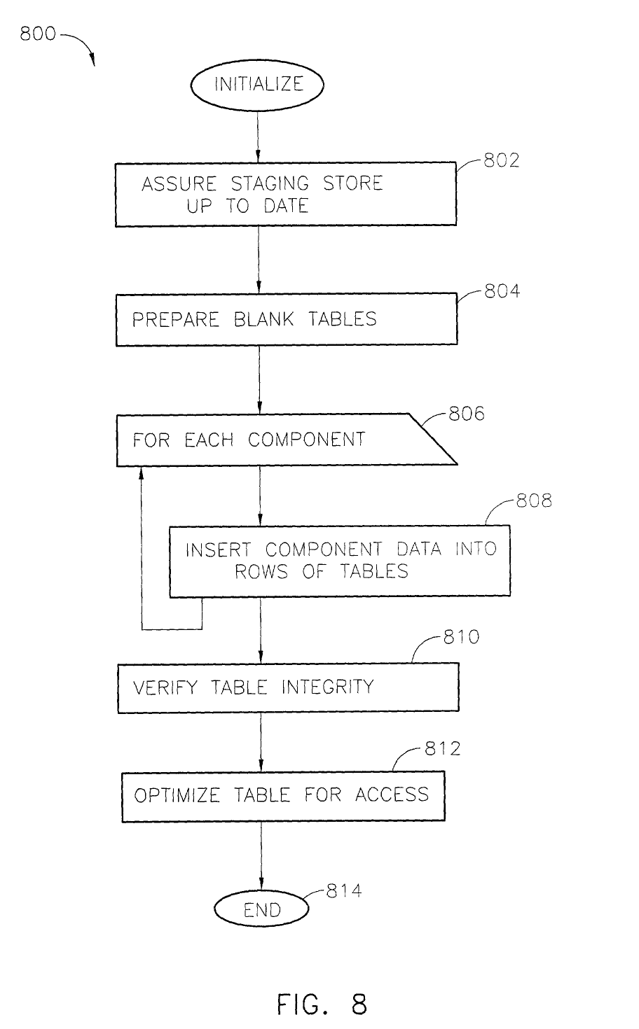

An initialize process for implementing an API according to various aspects of the present invention may perform a method that inserts component data into tables, verifies table integrity, and then optimizes each table for efficient read/write access. For example, method 800 of FIG. 8 may be performed as part of initialize process 432. Initializing begins with assuring (802) that the contents of staging store 206 is up to date with respect to environment memory 401. If not, transfer of components from environment memory 401 to staging store 206 may proceed as discussed above with reference to FIG. 2. Blank tables are then prepared (804) in any conventional manner such as by allocating working memory of configuration and state store 214 for tables 442-450, clearing allocated space, and/or emptying a linked list. Process 432 then proceeds (806) for each component read from staging store 206 to insert (808) the contents of the data 310 portion of the component into rows of tables of the type identified in data type 312 until all components have been read from staging store 206. Process 432 then verifies (810) the integrity of each table, for example, by applying tests described in Table 8. Process 432 optimizes each table for access, for example, by performing operations described in Table 9. Alternatively, each table may be verified and optimized prior to performing verification on another table.

TABLE 8

| Table | Integrity tests |
|---|---|
| Port table | Each row must have a port identifier field value that is unique |
| 442 | over the entire port table. The symbolic value in each of the |
| | following fields must have a proper physical address (prior to |
| | linking, may test a symbol table built by process 432; after |
| | linking, may test field values): port identifier, and LRU name. |
| | References to registers must be within a predetermined range. |
| Message | All rows having the same port identifier field value and |
| table 444 | message identifier field value are to be in one contiguous |
| | group. The API parameter owner field must have a proper |
| | value (this field is null or absent from the environment mem- |
| | ory). The symbolic value in each of the following fields must |
| | have a proper physical address (may test a symbol table built |
| | by process 432 or test fields after linking): conversion opcode, |
| | conversion argument if expected to be an opcode, port |
| | identifier, message identifier, API parameter name. |
| Routing | None. |
| table 445 | |
| Conver- | All rows having the same port identifier and message |
| sion | identifier are to be in one contiguous group. The existence of |
| table 446 | a noncontiguous second group of rows for the same port |
| | identifier and message identifier may indicate origin from |
| | different components which may be considered an error. The |
| | last row of every series must have a “RETURN” or “INVAL” |
| | conversion opcode value. Every row having a relative jump |
| | conversion opcode (herein called a branch row) shall jump a |
| | positive (forward) number of rows and the destination row of |
| | the jump must have the same port identifier and message |
| | identifier as the branch row. |
| String | Each row must have a name field value that is unique over the |
| table 448 | entire string table (or over names of the same type). |

TABLE 9

| Table | Optimization operations |
|---|---|
| Port | Substitute a physical address of the target for the field value of |
| table 442 | the following fields: port identifier field (target is in string |
| | table 448), and LRU field (target is in string table 448). |
| Message | Substitute a physical address of the target for the field value |
| table 444 | of the following fields: port identifier field (target is in port |
| | table 442), message identifier field (target is in string table |
| | 448), API parameter handle field (target is in data table 450), |
| | API parameter name field (target is in string table 448), API |
| | parameter owner field (target is in string table 448), con- |
| | version opcode field (target is entry point in process 436), |
| | conversion argument field when conversion opcode is |
| | “REDIRECT” (target is in conversion table 446), and con- |
| | version argument field when conversion opcode takes an API |
| | parameter name as a conversion argument (e.g., GETAPI, |
| | SETAPI, INAPI, OUTAPI) (target is in data table 450). |
| Routing | Substitute a physical address of the target for the field value |
| table 445 | of the following fields: port identifier field (target is in port |
| | table 442), message identifier field (target is in string table |
| | 448), series start field (target is in message table 444); |
| Conver- | Substitute a physical address of the target for the field value |
| sion | of the following fields: port identifier field (target is in port |
| table 446 | table 442), message identifier field (target is in string table |
| | 448), conversion opcode field (target is entry point in process |
| | 436), and conversion argument field when conversion opcode |
| | takes an API parameter name as a conversion argument (e.g., |
| | GETAPI, SETAPI, INAPI, OUTAPI) (target is in data table |
| | 450). |
| String | Substitute a physical address of the target for the field value |
| table 448 | of the reference code field when the name field (e.g., as |
| | indicated by type) is used for: API parameter name (target is |
| | in data table when API parameter name is used for input) |
| | (target is in message table 444 when API parameter is used |
| | for output). |

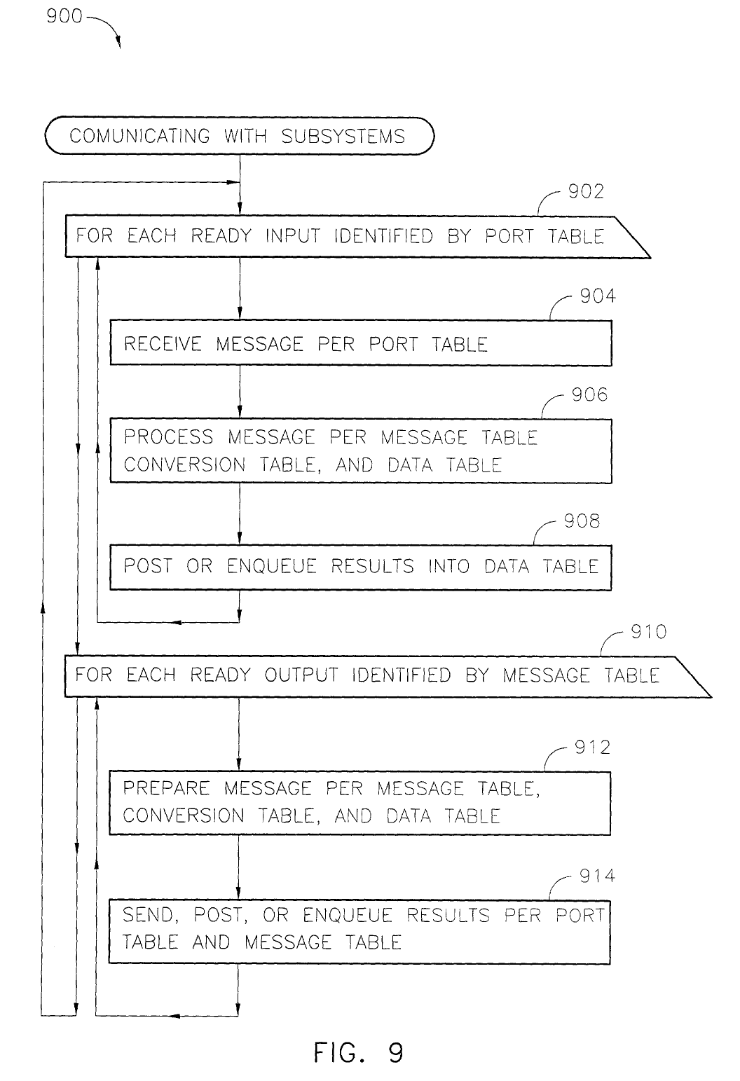

A method for communicating with subsystems, according to various aspects of the present invention, includes any method that performs input servicing or output servicing according to two tables. In a first implementation, a first table describes ports and a second table describes a group of processes for disposition of the input or for preparation of the output. In a second implementation, a first table describes ports, and a second table describes messages. In a third implementation, a first table describes group of processes for disposition of the input or for preparation of the output, and a second table describes messages. In a fourth implementation, a first table describes messages and a second table describes a method for at least one of source selection, validation, conversion, and output to a port or to shared memory. In a fifth implementation, a first table describes names and a second table describes messages. In a sixth implementation, a first table describes names and a second table describes shared memory. In a preferred method for communicating with subsystems, all six implementations are combined. For example, method 900 of FIG. 9 includes a first loop (902-908) for input servicing and a second loop (910-914) for output servicing, the first and second loop being part of an outer infinite loop (902-914). Method 900 may be performed by ports managing engine 406, for example, as a combination of instrument I/O process 434 and interpret process 436, as discussed above.

For each ready input (902) identified by a row of a port table 442, the body of the input servicing loop (902-908) is performed. Ports managing engine 406 may determine when an input is ready using any conventional technique. An input is ready, according to a preferred implementation, when the input is implemented with an I/O buffer organized as a linked list of messages (e.g., implementing a FIFO or a queue); and, the tail pointer of the list is not identical to the head pointer of the list. The port table provides a list of rows that may be considered one at a time. Each row having an SDI indicating source is an input port. Physical addresses of one or more registers are included in the row for determining input readiness.

Ports managing engine 406 receives (904) a message according to field values of the row of the port table that described the port. The port table provides physical addresses of one or more registers for obtaining a message from the I/O buffer.

The received message's type in combination with identification of the port it came from identifies a row of message table 444. The received message is processed (906) according to the identified row which may include a conversion opcode, a reference to a series of conversion opcodes in conversion table 446, or a reference to shared memory where the results of processing (or simply the message with little or no processing) may be stored. The reference may be an API parameter name or a physical address in shared memory. Conversion opcodes are interpreted (or executed) and may refer to portions of data table 450 using physical addresses.

Results of processing are posted or enqueued (908) in at least one API parameter of data table 450. Reference to the portion of the data table for API parameter(s) is made by ports managing engine 406 with physical addresses. Reference to the portion of the data table for API parameter(s) updated as a consequence of one or more input messages is made by application program(s) 411 with a handle obtained in exchange for a name of the corresponding API parameter.

For each ready output identified by a row of message table 444, the body of the output servicing loop (910-914) is performed. Ports managing engine 406 may determine when an output is ready using any conventional technique. An output is ready, according to a preferred implementation, when data for preparing an output message is available or a period for awaiting the beginning of preparation has lapsed. The subject message table row identifies how to prepare (912) the message(s) for output. The subject row may include a conversion opcode, a reference to a series of conversion opcodes in conversion table 446, or a reference to shared memory where the results of preparation (or simply the message with little or no preparation) may be recalled. The reference may be an API parameter name or a physical address in shared memory. Conversion opcodes are interpreted (or executed) and may refer to portions of data table 450 using physical addresses.

Message data may be prepared with reference to API parameter(s) of data table 450. Reference to the portion of data table 450 for API parameter(s) is made by ports managing engine 406 with physical addresses. Reference to the portion of the data table for API parameter(s) to direct output of one or more messages is made by application program(s) 411 with a handle obtained in exchange for each name of a corresponding API parameter. Ports managing engine 406 sends, posts, or enqueues (914) the prepared message(s) to a port or to shared memory described by a row of port table 442. The port table row is identified by the port identifier field of the subject message table row. Sending may be accomplished merely by posting or enqueueing the prepared message(s) into an I/O buffer of the type discussed above. Sending to a shared memory may be accomplished in a similar manner with physical addresses identified either in an API parameter field, in a conversion code argument, or in the port table row.

In an alternate implementation of each of the input loop and output loop discussed above, a plurality of message table rows may be used in processing input or preparing output, each message table row having a reference to zero, one, or a series of conversion opcodes. Routing table 445 identifies the plurality of message table rows, for example, as a contiguous list. Both the routing table and message table are indexed according to values of a tag, the tag combining the port identifier and message identifier for faster access. A plurality of message rows corresponding to one ready input may be identified as follows: for one message table row that indicates ready input, use the value of the tag to locate a first row of a contiguous group of rows in routing table 445; then for each row of the contiguous group, process the message row it identifies. Each ready output row is identified as follows: for each row of routing table 445, if the subject row identifies a different tag than seen in the prior row (i.e., it is a first row of a contiguous group), use the tag to locate a row in message table 444; if the located row indicates ready output, then process a plurality of rows in series from message table 444 up to the number of rows indicated in the subject row of routing table 445.

The foregoing description discusses preferred embodiments of the present invention which may be changed or modified without departing from the scope of the present invention as defined in the claims. While for the sake of clarity of description, several specific embodiments of the invention have been described, the scope of the invention is intended to be measured by the claims as set forth below.

What is claimed is:

1. A method for communicating among subsystems, the method performed by an avionics subsystem, the subsystem being one of a plurality of subsystems that communicate as a system, the method comprising:
a step for forming a first table having a plurality of rows and a first particular row of the plurality, each row of the first table formed in a memory internal to the subsystem in accordance with at least one first component stored in a memory external to the subsystem, the first table describing at least one communication path between the subsystem and other subsystems;
a step for forming a second table having a plurality of rows and a second particular row of the plurality, each row of the second table formed in the memory internal to the subsystem in accordance with at least one second component stored in the memory external to the subsystem, the second table describing message content for communicating between the subsystem and other subsystems; wherein each first component and each second component comprises data for a respective plurality of rows and is identified by a respective signature, data for at least one row of any component comprising a symbolic row reference;
a step for linking the first particular row to the second particular row in accordance with a physical address of the internal memory to implement the symbolic row reference;
a step for executing processes that communicate with other subsystems in accordance with the first table and the second table to provide access by an avionics application program of the subsystem to message content accessed with reference to a handle in a row of the second table for at least one of a send communication and a receive communication, the application program gaining knowledge of the handle after formation of the first table and the second table.

2. In a system having a plurality of subsystems coupled for communication among the subsystems, a method for communicating among subsystems, the method performed by a subsystem of the plurality, the method comprising:
a step for obtaining data provided by a memory, the subsystem being removably coupled to the memory, the memory for subsystem configuration control, the data comprising a multiplicity of respective pluralities of rows, each plurality being identified for at least one particular table of a set of tables, there being no reference in the data from a first plurality of the multiplicity identified for a first table to a second plurality of the multiplicity identified for the first table;
a step for storing each respective plurality of rows so that all rows identified for each respective table may be accessed in series without accessing rows of any other than the respective table; and
a step for communicating with other subsystems in accordance with rows of the tables.

3. The method of claim 2 wherein:
the data is provided in components; and
each component comprises a signature and a plurality of rows of the multiplicity.

4. The method of claim 3 wherein the step for obtaining comprises a step for copying the data from the memory to a nonvolatile memory within the subsystem and and a step for reading the data from the nonvolatile memory.

5. The method of claim 4 wherein the set of tables comprises a first table having rows from more than one of the pluralities of rows, each row of the first table comprising indicia identifying a buffer for communication between the first subsystem and a second subsystem.

6. The method of claim 5 wherein other rows of the first table comprise indicia identifying alternatively a buffer for communication between the first subsystem and a second subsystem, and a buffer for communication between a first process and a second process, wherein the first process and the second process are performed by the first subsystem.

7. The method of claim 5 wherein the set of tables further comprises a second table having rows from more than one of the pluralities of rows, each row of the second table comprising indicia for determining the address of a parameter having a value responsive to communication between the first subsystem and the second subsystem.

8. The method of claim 7 wherein the set of tables further comprises a third table having rows from more than one of the pluralities of rows, a plurality of rows of the third table comprising at least one of a communicated data validation algorithm, a communicated data conversion algorithm, an algorithm for selecting a subsystem for communication, and a communication algorithm for communicating between the first subsystem and the second subsystem.

9. The method of claim 5 wherein the set of tables further comprises a second table having rows from more than one of the pluralities of rows, each row of the second table comprising indicia for determining the address of a parameter, communication between the first subsystem and the second subsystem being in accordance with a value of the parameter.

10. In a system having a plurality of subsystems coupled for communication among the subsystems, a method for communicating among subsystems, the method performed by a subsystem of the plurality, the method comprising:
a step for obtaining data provided by a memory, the subsystem being removably coupled to the memory, the memory for subsystem configuration control, the data comprising values and symbolic addresses that refer to particular ones of the values;
a step for storing the values in respective physical addresses; and
a step for linking the values so that each value referred to by a symbolic address is accessed instead with reference to a physical address, communication between the subsystem and other subsystems of the plurality being accomplished in accordance with the linked values.

11. The method of claim 10 wherein:
the data is provided in components; and
each component comprises a signature and a plurality of rows of the multiplicity.

12. The method of claim 11 wherein the step for obtaining comprises a step for copying the data from the memory to a nonvolatile memory within the subsystem and a step for reading the data from the nonvolatile memory.

13. The method of claim 12 wherein the data comprises a first component having a particular one of the values and a second component having a symbolic address that refers to the particular one of the values.

14. The method of claim 13 wherein the set of tables comprises a first table having rows from more than one of the pluralities of rows, each row of the first table comprising indicia identifying a buffer for communication between the first subsystem and a second subsystem.

15. The method of claim 14 wherein other rows of the first table comprise indicia identifying alternatively a buffer for communication between the first subsystem and a second subsystem, and a buffer for communication between a first process and a second process, wherein the first process and the second process are performed by the first subsystem.

16. The method of claim 14 wherein the set of tables further comprises a second table having rows from more than one of the pluralities of rows, each row of the second table comprising indicia for determining the address of a parameter having a value responsive to communication between the first subsystem and the second subsystem.

17. The method of claim 16 wherein the set of tables further comprises a third table having rows from more than one of the pluralities of rows, a plurality of rows of the third table comprising at least one of a communicated data validation algorithm, a communicated data conversion algorithm, an algorithm for selecting a subsystem for communication, and a communication algorithm for communicating between the first subsystem and the second subsystem.

18. The method of claim 14 wherein the set of tables further comprises a second table having rows from more than one of the pluralities of rows, each row of the second table comprising indicia for determining the address of a parameter, communication between the first subsystem and the second subsystem being in accordance with a value of the parameter.

19. A method for communicating among subsystems, the method performed by a subsystem of a system, the system comprising the subsystem and a plurality of other subsystems, the subsystem coupled to an environment memory, the method comprising:
a step for obtaining data provided by the environment memory, the data comprising a multiplicity of respective pluralities of rows, each plurality being identified for at least one of a first table and a second table, there being no reference in the data from a first plurality of the multiplicity identified for the first table to a second plurality of the multiplicity identified for the first table, there being no reference in the data from a third plurality of the multiplicity identified for the second table to a fourth plurality of the multiplicity identified for the second table;
a step for storing each respective plurality of rows so that all rows identified for each respective table may be accessed in series without accessing rows of any other than the respective table, and
a step for communicating with a particular other subsystem of the plurality of other subsystems in accordance with a buffer and a process, the buffer being identified by a row of the first table, the process being identified by a row of the second table.

20. The method of claim 19 wherein
the row of the first table comprises a symbolic reference to the row of the second table;
the row of the second table is stored at least in part at a physical address; and
the row of the second table is accessed with reference to the physical address.

21. The method of claim 20 wherein the process comprises at least one of a data validation algorithm, a data conversion algorithm, a subsystem selection algorithm, and a communication algorithm for communicating between the particular other subsystem and an application program performed by the subsystem.

22. The method of claim 21 wherein the row of the second table is identified in accordance with indicia of the row of the first table and indicia of message type of a message in the buffer.

23. The method of claim 22 wherein:
each plurality is identified for at least one of the first table, the second table, and a third table; and
the process performs in accordance with a list accessed from rows of the third table.

24. The method of claim 23 wherein the list comprises operation codes.

25. The method of claim 24 wherein the list comprises physical addresses to which control is transferred to perform the process.

26. In a system having a subsystem and a plurality of other subsystems coupled for communication, a method performed by the subsystem, the method for providing an application program interface for an application program performed by the subsystem, the method comprising:
a step for arranging a plurality of rows for access as a table, each row comprising a respective reference to a respective parameter of the application program interface; and
a step for allocating a row of a data table in accordance with each reference, wherein the data table is for communication between the application program and at least one of the other subsystems.

27. The method of claim 26 further comprising:
a step for obtaining each row of the plurality of rows from a memory exterrnal to the subsystem.

28. The method of claim 27 wherein the plurality of rows is obtained from a plurality of components stored in the memory.

29. The method of claim 28 wherein each component comprises a signature.

30. The method of claim 29 wherein each reference comprises a symbolic name of the respective application program interface parameter independent of any physical address of the memory.

31. In a system having a subsystem and a plurality of other subsystems coupled for communication, a method performed by the subsystem, the method for communicating between an application program of the subsystem and at least one other subsystem, the method comprising:
a step for determining content of a port table in accordance with first data of a memory external to the subsystem;
a step for receiving data from an input port, the input port being identified by a row of the port table; and
a step for transferring at least a portion of the received data to an application program interface parameter portion of a data table for subsequent access by the application program.

32. The method of claim 31 further comprising:
a step for determining content of a message table in accordance with second data of the memory external to the subsystem; and
a step for identifying the portion of the data table with reference to a row of the message table, the message table row accessed in accordance with the row of the port table.

33. The method of claim 32 further comprising:
a step for identifying the portion of the data table with reference to a conversion operation identified by the message table row.

34. The method of claim 33 further comprising:
a step for determining content of a conversion table in accordance with third data of the memory external to the subsystem; and
a step for identifying the portion of the data table with reference to a series of rows of the conversion table, the series being identified by the message table row.

35. The method of claim 34 further comprising:
a step for determining content of a routing table in accordance with content of the message table; and
a step for identifying the message table row with further reference to a row of the routing table, the row of the routing table being identified in accordance with at least one of the row of the port table and the received data.

36. The method of claim 35 further comprising:
a step for identifying a plurality of message table rows, each message table row for identifying a respective portion of the data table.

37. The method of claim 36 further comprising:
a step for determining content of a string table in accordance with fourth data of the memory external to the subsystem; and
a step for identifying the portion of the data table in accordance with a value of a name field of a string table row.

38. In a system having a subsystem and a plurality of other subsystems coupled for communication, a method performed by the subsystem, the method for communicating between an application program of the subsystem and at least one other subsystem, the method comprising:
a step for determining content of a message table in accordance with first data of the memory external to the subsystem;
a step for determining content of a port table in accordance with third data of a memory external to the subsystem;
a step for determining that a message described by a row of the message table is to be prepared;
a step for performing a process to prepare the message, the process identified in accordance with the row of the message table, the message comprising data from an application program interface parameter portion of a data table; and
a step for transferring the message to an output port identified by a row of the port table.

39. The method of claim 38 further comprising:
a step for determining content of a routing table in accordance with second data of a memory external to the subsystem, wherein the process is further identified as a member of a series of processes identified in accordance with the routing table and the row of the message table.

40. The method of claim 39 further comprising:
a step for determining content of a conversion table in accordance with fourth data of a memory external to the subsystem, wherein the process is performed in accordance with a plurality of operation codes of the conversion table.

41. The method of claim 40 further comprising:
a step for determining content of a string table in accordance with fourth data of the memory external to the subsystem; and
a step for identifying the portion of the data table in accordance with a value of a name field of a string table row.

42. In a system having a subsystem and a plurality of other subsystems coupled for communication, a method performed by the subsystem, the method for processing data for communicating between an application program of the subsystem and at least one other subsystem, the method comprising:
a step for forming a data table and a message table in accordance with first data of a memory external to the subsystem;
a step for determining content of a conversion table in accordance with second data of the memory external to the subsystem; and
a step for reading a first parameter of the data table and writing a second parameter of the data table, the first parameter being identified by a row of the message table, the second parameter being identified in accordance with the content of the conversion table.

43. The method of claim 42 further comprising:
a step for forming a port table in accordance with third data of the memory external to the subsystem; wherein
at least one of reading and writing is performed with reference to a row of the port table.

44. The method of claim 43 wherein reference is made to indicia of type, wherein type identifies whether at least one of reading and writing is accomplished with referenct to one of a port and a parameter.

45. An application program interface for a subsystem of a system, the system including the subsystem and a plurality of other subsystems, the interface comprising:
a first table comprising rows, each first table row comprising a respective name and a respective link value, the application program comprising references to respective names; and
a second table comprising rows, each second table row comprising a handle to memory, access to the memory being facilitated by the name, the link value, and the handle, access being for communicating between the susystem and at least one of the other subsystems.

46. A method for initializing an application program interface for a subsystem of a system, the system including the subsystem and a plurality of other subsystems, the method comprising:
a step for reading a plurality of components from a memory external to the subsystem;
a step for forming a data table and a message table in accordance with the components;
a step for verifying integrity of the message table; and
a step for linking a row of the message table to a row of the data table.

47. The method of claim 46 wherein the step of verifying comprises a step for testing whether a field of the message table comprises a value that identifies a portion of the data table.

48. A method for initializing an application program interface for a subsystem of a system, the system including the subsystem and a plurality of other subsystems, the method comprising:
a step for reading a plurality of components from a memory external to the subsystem;
a step for forming a conversion table and a message table in accordance with the components;
a step for verifying integrity of the message table; and
a step for linking a row of the message table to a row of the conversion table.

49. The method of claim 48 wherein the step of verifying comprises a step for testing whether a field of the message table comprises a value that identifies a portion of the conversion table.

50. The method of claim 48 further comprising a step for verifying integrity of the conversion table.

51. The method of claim 50 wherein the step for verifying integrity of the conversion table comprises testing whether the conversion table comprises an opcode invoking a transfer of control as in at least one of repetition and recursion.

52. A method for initializing an application program interface for a subsystem of a system, the system including the subsystem and a plurality of other subsystems, the method comprising:
a step for reading a plurality of components from a memory external to the subsystem;
a step for forming a port table, a message table, and a routing table in accordance with the components;
a step for verifying integrity of the port table; and
a step for verifying integrity of the message table.

53. The method of claim 52 wherein the step for verifying the integrity of the message table comprises a step for grouping rows of the message table having references to a common message identifier.

54. The method of claim 52 wherein the step for verifying the integrity of the message table comprises a step for grouping rows of the message table having references to a common message identifier and a common port identifier.
